(19) United States
(12) Patent Application Publication
(10) Pub. No.: US 2026/0084760 A1
(43) Pub. Date: Mar. 26, 2026

(54) VEHICLE

(71) Applicant: KAWASAKI MOTORS, LTD., Hyogo (JP)

(72) Inventors: Kota HIDAKA, Akashi-shi (JP); Hirotaka FUJIKI, Akashi-shi (JP); Daisuke SAEKI, Lincoln, NE (US); Kazunori KANAZAWA, Akashi-shi (JP); Yuusuke NAKASHIMA, Akashi-shi (JP); Nickle CHASE, Lincoln, NE (US); Loran FORTIK, Lincoln, NE (US); Bradley KATHOL, Lincoln, NE (US)

(73) Assignee: KAWASAKI MOTORS, LTD., Hyogo (JP)

(21) Appl. No.: 18/892,587

(22) Filed: Sep. 23, 2024

(51) Int. Cl. B62D 25/24; B62D 25/06; B62D 25/14

(52) U.S. Cl. CPC B62D 25/24; B62D 25/06; B62D 25/14

(57) ABSTRACT

A utility vehicle 100 includes a vehicle body frame 1, pillars 2 attached to the vehicle body frame 1 and extending in an up-down direction, a roof 3 supported by the pillars 2, and a harness 4 connected to an electric component 5. The pillars 2 include a hollow tubular front pillar 21. The front pillar 21 has an upper end hole 25 opening at an upper end 21a, a lower end hole 26 opening at a lower end 21b, a first hole 27 opening in a side wall 21c, and a second hole 28 opening in the side wall 21c and positioned lower than the first hole 27. The roof 3 has a drain hole 33. The drain hole 33 faces and communicates with the upper end hole 25. The harness 4 is inserted into the front pillar 21 through the first hole 27 and the second hole 28.

### FIELD

A technique disclosed here relates to a vehicle.

### BACKGROUND

U.S. Patent Application Publication No. 2021/0094627 discloses an off-road vehicle. The off-road vehicle includes a lower frame and an upper frame attached to the lower frame. The upper frame has pillars extending in an up-down direction.

### SUMMARY

In the above-described off-road vehicle, for example, in a case where a roof is disposed on the upper frame and rainwater on the roof is drained, a drainpipe for draining the rainwater may be separately disposed. Alternatively, in a case where an electric component is disposed in the vehicle and a harness connected to the electric component is drawn, a cover surrounding the harness and defining a harness drawing path may be separately disposed. However, if the drainpipe or the cover is separately disposed in order to add a predetermined function to the vehicle, the number of components increases.

The technique disclosed here has been made in view of the above-described point, and an object thereof is to suppress an increase in the number of components even if a predetermined function is added.

A vehicle disclosed here includes a vehicle body frame, pillars attached to the vehicle body frame and extending in an up-down direction, a roof supported by the pillars, and a harness connected to an electric component. The pillars include a hollow tubular first pillar, the first pillar has an upper end hole opening at an upper end, a lower end hole opening at a lower end, a first hole opening in a side wall, and a second hole opening in the side wall and positioned lower than the first hole, the roof has a drain hole, the drain hole faces and communicates with the upper end hole, and the harness is inserted into the first pillar through the first hole and the second hole.

A vehicle disclosed here includes a vehicle body frame, a hollow tubular pillar attached to the vehicle body frame and extending in an up-down direction, a harness connected to an electric component, a fastening member penetrating a side wall of the pillar and fixing the pillar to the vehicle body frame, and a reinforcing plate attached to the outer surface of the side wall of the pillar, the pillar has a hole opening in the side wall, the harness is inserted into the pillar through the hole, the hole is positioned in the vicinity of the fastening member, the fastening member penetrates the reinforcing plate, and the reinforcing plate is located so as to surround the hole.

A vehicle disclosed here includes a vehicle body frame, pillars attached to the vehicle body frame and extending in an up-down direction, and a roof supported by the pillars, the pillars include a hollow tubular first pillar, the first pillar has an upper end hole opening at an upper end and a lower end hole opening at a lower end, the roof has a drain hole, and the drain hole faces and communicates with the upper end hole.

### BRIEF DESCRIPTION OF THE DRAWINGS

FIG. 1 is a left side view of a utility vehicle according to an embodiment.

FIG. 2 is a simple sectional view of a left front pillar.

FIG. 3 is a perspective view showing a roof from the front and above.

FIG. 4 is a simple sectional view showing a connection portion between the roof and the left front pillar.

FIG. 5 is a perspective view showing the roof from the front and below.

FIG. 6 is a simple plan view showing the left front pillar from above.

FIG. 7 is a sectional view of the left front pillar in a section extending perpendicular to the axis of the left front pillar and passing through the center of gravity of a first hole.

FIG. 8 is a perspective view showing, from the front and above, the state of attachment of the left front pillar to a vehicle body frame.

FIG. 9 is a perspective view showing, from the rear and above, the state of attachment of the left front pillar to the vehicle body frame.

FIG. 10 is a simple sectional view showing a lower portion of the left front pillar.

FIG. 11 is a side view showing a front portion of the utility vehicle from the left side.

### DESCRIPTION OF EMBODIMENTS

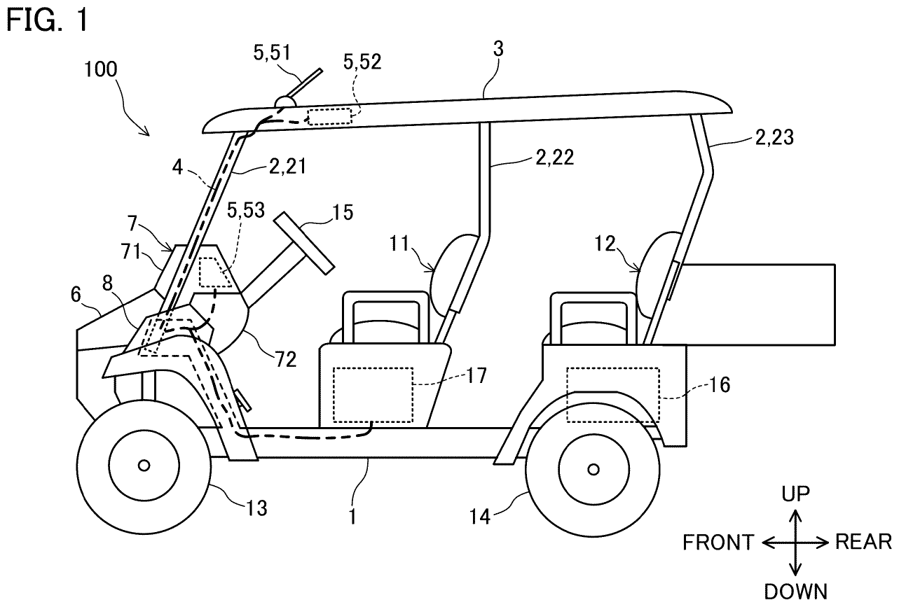

Hereinafter, an exemplary embodiment will be described in detail with reference to the drawings. FIG. 1 is a left side view of a utility vehicle 100. Hereinafter, the utility vehicle 100 will also be referred to as a “vehicle 100.”

The vehicle 100 is equivalent to one example of a vehicle of the present disclosure. The vehicle 100 is a vehicle intended for traveling at a low speed in a limited area. The limited area is, for example, a limited community area, private road, or private property (e.g., golf course or park). The limited community area is an area for use by a community resident. The community area is, for example, an area including houses and community facilities (e.g., school and hospital), where the vehicle 100 not intended for traveling on a public road is allowed to travel at the low speed. The low speed is, for example, a speed of 20 mph to 30 mph at a maximum. Note that the vehicle 100 may travel at a speed of 20 mph or less or 30 mph or more. The vehicle 100 includes, for example, a personal transport vehicle (PTV). The PTV includes a golf cart. Note that the vehicle 100 may be other golf carts such as a low speed vehicle (LSV).

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing forward of the vehicle 100, and a “right” means the right when facing forward of the vehicle 100. A “vehicle width direction” means the vehicle width direction of the vehicle 100, and in other words, means the right-left direction of the vehicle 100 and may be referred to as a “right-left direction.” An “inside in the vehicle width direction” means a vehicle interior side in the vehicle width direction, and an “outside in the vehicle width direction” means a vehicle exterior side in the vehicle width direction. In the present disclosure, a member extending or expanding in a certain direction includes not only a member precisely extending or expanding parallel with a certain direction, but also a member substantially extending or expanding in a certain direction.

The vehicle 100 includes a vehicle body frame 1, pillars 2 attached to the vehicle body frame 1 and extending in an up-down direction, a roof 3 supported by the pillars 2, and a harness 4 connected to an electric component 5.

The vehicle body frame 1 is a portion as a lower framework of the vehicle 100. The vehicle body frame 1 is configured, for example, such that metal pipe components, metal plate components, or casted components are combined with each other. The vehicle body frame 1 includes vertical frames extending in the front-rear direction and aligned in the vehicle width direction and horizontal frames extending in the vehicle width direction and aligned in the front-rear direction.

The pillars 2 have a front pillar 21, a center pillar 22, and a rear pillar 23. The front pillar 21 is also called an A-pillar, the center pillar 22 is also called a B-pillar, and the rear pillar 23 is also called a C-pillar. In a case where the front pillar 21, the center pillar 22, and the rear pillar 23 are not distinguished from each other, these pillars will be merely referred to as a “pillar(s) 2.” A lower portion of the pillar 2 is supported by the vehicle body frame 1, and an upper portion of the pillar 2 supports the roof 3. The pillar 2 is in a hollow tubular shape. The section of the pillar 2 perpendicular to the axis thereof is in a circular shape. The pillar 2 may be made of metal or resin.

The front pillar 21, the center pillar 22, and the rear pillar 23 are located in this order from the front to the rear. The front pillar 21, the center pillar 22, and the rear pillar 23 are disposed on each of the right and left sides in the vehicle width direction.

The front pillars 21 and the center pillars 22 define a front vehicle interior. The center pillars 22 and the rear pillars 23 define a rear vehicle interior. The front vehicle interior and the rear vehicle interior are opened without closed with a wall or a door so that an occupant can easily get on and off the vehicle 100. In this case, the occupant can walk through the vehicle interior in the right-left direction without blocked by a door or a wall.

The roof 3 is supported by the front pillars 21, the center pillars 22, and the rear pillars 23. The roof 3 expands in the front-rear direction and the right-left direction to cover above the vehicle interior. The roof 3 may be made of metal or resin.

The harness 4 includes electric wires, and the electric wires include a power supply electric wire and a signal communication electric wire. The power supply electric wire is connected to the electric component 5 and a battery 17 to supply electric energy from the battery 17 to the electric component 5. The signal communication electric wire is connected to the electric component 5 to communicate a signal to the electric component 5. The electric wires are bundled. For example, a connector is attached to an end portion of the electric wire. In FIG. 1, the harness 4 is indicated by a dash-dot-dot line for the sake of convenience.

The electric component 5 includes an antenna 51, a speaker 52, and an audio 53. The antenna 51 and the speaker 52 are located on the roof 3. The audio 53 is located in a dashboard 7. In a case where the antenna 51, the speaker 52, and the audio 53 are not distinguished from each other, these components will be merely referred to as an “electric component(s) 5.” The electric component 5 may include, for example, an LED light, a light bar, and other accessories.

The vehicle 100 further has a front seat 11 and a rear seat 12. The front seat 11 and the rear seat 12 are supported by the vehicle body frame 1. The front seat 11 and the rear seat 12 are located on each of the right and left sides in the vehicle width direction. The front seat 11 is positioned forward of the rear seat 12. The front seat 11 is located in the front vehicle interior. The rear seat 12 is located in the rear vehicle interior.

The vehicle 100 further has a front wheel 13 and a rear wheel 14. The front wheel 13 supports a front portion of the vehicle body frame 1. The rear wheel 14 supports a rear portion of the vehicle body frame 1. The front wheel 13 and the rear wheel 14 are located on each of the right and left sides in the vehicle width direction. That is, the vehicle 100 is a four-wheeled vehicle.

The vehicle 100 further has a panel. The panel covers various components supported by the vehicle body frame 1. The panel defines the outer appearance of the vehicle 100. The panel includes a hood 6, the dashboard 7, and a fender 8.

The hood 6 is attached to a front portion of the vehicle body frame 1. The hood 6 is located on the vehicle exterior side. The hood 6 is equivalent to an upper cover of a front portion of the vehicle 100.

The dashboard 7 is attached to the vehicle body frame 1 in rear of the hood 6. The dashboard 7 is located in the vehicle interior. The dashboard 7 is located so as to face the front seat 11.

The dashboard 7 has an upper board 71 and a lower board 72. The upper board 71 is located above the lower board 72. The audio 53 is located in the upper board 71. A drink holder and a speed meter are further located in the upper board 71. A glove compartment is located in the lower board 72.

A steering wheel 15 is located rearward of the dashboard 7. A driver operates the steering wheel 15 to change the angle of each front wheel 13 with respect to an axle thereof, so that the traveling direction of the vehicle 100 can be changed.

The vehicle 100 further has a motor 16 and the battery 17. The motor 16 is an electric motor that converts the electric energy into rotary motion for traveling. The battery 17 stores the electric energy and supplies the electric energy to the motor 16 and the electric component 5. The motor 16 is located in a lower portion of the rear seat 12. The battery 17 is located in a lower portion of the front seat 11. Note that the motor 16 may be an internal combustion engine and the vehicle 100 has a fuel tank in this case.

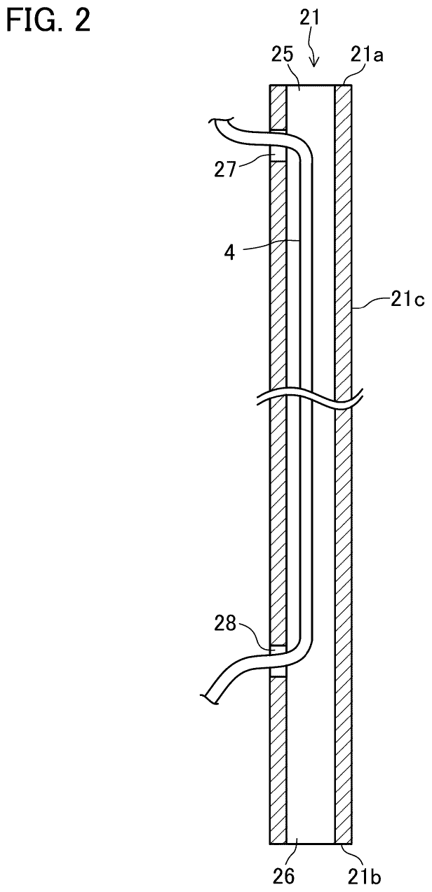

FIG. 2 is a simple sectional view of the left front pillar 21. The left front pillar 21 is equivalent to one example of a first pillar of the present disclosure. Hereinafter, the left front pillar 21 will be described.

The front pillar 21 is in a hollow tubular shape, specifically a hollow cylindrical shape. The front pillar 21 includes an upper end hole 25, a lower end hole 26, a first hole 27, and a second hole 28. The upper end hole 25 opens at the upper end 21a of the front pillar 21. The lower end hole 26 opens at the lower end 21b of the front pillar 21. The upper end hole 25 faces the roof 3, and the lower end hole 26 faces the front wheel 13. The first hole 27 and the second hole 28 open in the side wall 21c of the front pillar 21. The second hole 28 is positioned lower than the first hole 27. The first hole 27 is positioned in the vicinity of the upper end hole 25, and the second hole 28 is positioned in the vicinity of the lower end hole 26. The first hole 27 and the second hole 28 are in a circular shape, but may be in other shapes such as an elliptical shape, an oval shape, and a polygonal shape.

The harness 4 is inserted into the front pillar 21 through the first hole 27 and the second hole 28. Specifically, the harness 4 is drawn into the front pillar 21 such that a first end of the harness 4 is drawn out of the front pillar 21 through the first hole 27 and a second end of the harness 4 is drawn out of the front pillar 21 through the second hole 28.

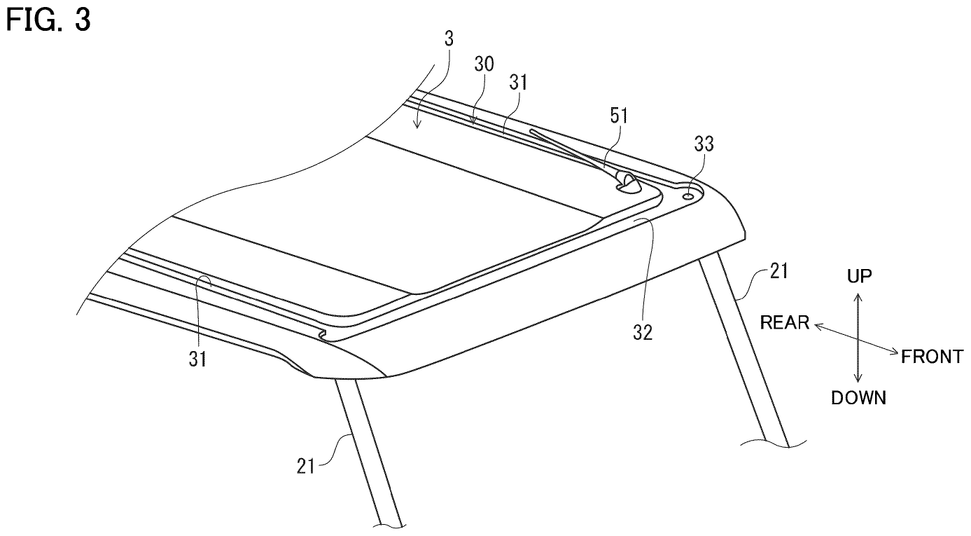

FIG. 3 is a perspective view showing the roof 3 from the front and above. The roof 3 includes a drain hole 33. Specifically, the roof 3 has a drain 30 in the upper surface thereof. The drain 30 has the drain hole 33 in the bottom thereof.

Specifically, the drain 30 is an annular shape in plan view. The drain 30 includes a first groove 31 extending in the front-rear direction and a second groove 32 extending in the right-left direction. The first groove 31 is located on each of the right and left sides in the vehicle width direction. The second groove 32 is located on each of the front and rear sides in the front-rear direction. The right and left first grooves 31 and the front and rear second grooves 32 are connected in an annular shape. The drain hole 33 is located at a connection portion between the left first groove 31 and the front second groove 32.

The first groove 31 has a shape extending downward to the front side. The second groove 32 has a shape extending downward to the left side. That is, the first groove 31 and the second groove 32 has shapes extending downward to the drain hole 33 side. With this configuration, rainwater flowing along the first groove 31 and the second groove 32 moves to the drain hole 33 due to its own weight.

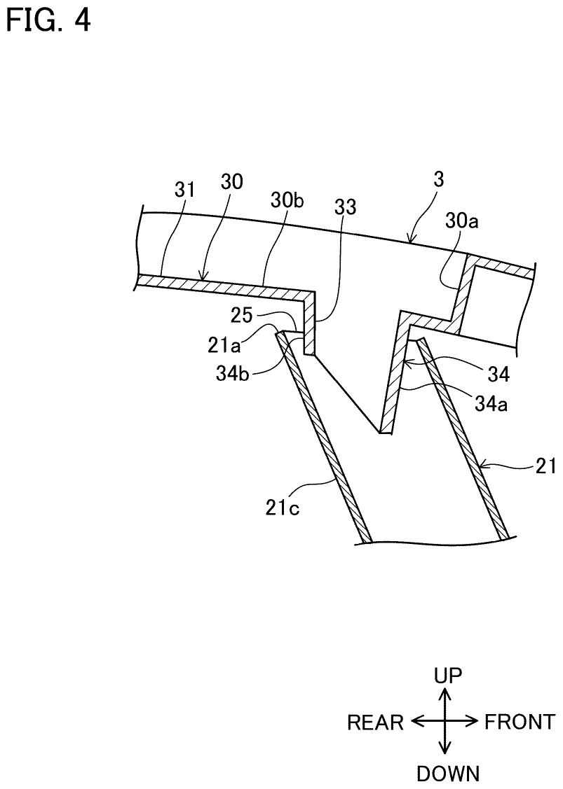

FIG. 4 is a simple sectional view showing a connection portion between the roof 3 and the left front pillar 21. The drain hole 33 of the roof 3 faces and communicates with the upper end hole 25 of the front pillar 21. Specifically, the roof 3 has, at the lower surface thereof, a tubular portion 34 protruding downward. The tubular portion 34 penetrates the lower surface of the roof 3. The drain hole 33 is equivalent to the inside of the tubular portion 34. The tubular portion 34 is inserted into the upper end hole 25 of the front pillar 21. A front side wall portion 34a of the tubular portion 34 extends to a position lower than that of a rear side wall portion 34b of the tubular portion 34. With this configuration, the rainwater flowing along the drain hole 33 does not leak to the outside of the front pillar 21, and is guided into the front pillar 21. The rainwater inside the front pillar 21 is discharged to the outside through the lower end hole 26.

The drain 30 has a front side wall 30a. The front side wall 30a defines a front wall of the front second groove 32. The front side wall 30a extends in the right-left direction. The drain 30 has, in the bottom 30b thereof, the drain hole 33, and the drain hole 33 is located at a position apart rearward from the front side wall 30a. That is, part of the bottom 30b is present between the drain hole 33 and the front side wall 30a. With this configuration, the rainwater flowing forward along the drain 30 of the roof 3 is drained through the drain hole 33 before reaching the front side wall 30a. This can reduce the rainwater from flowing over the front side wall 30a and dropping from the front of the roof 3.

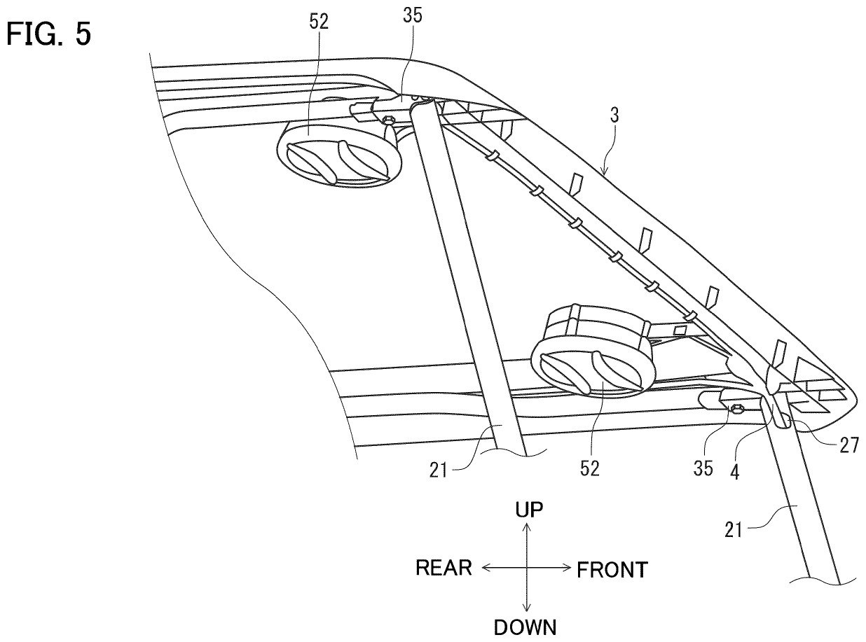

FIG. 5 is a perspective view showing the roof 3 from the front and below. An upper portion of the front pillar 21 is fixed to the lower surface of the roof 3 with a fixing member 35. The fixing member 35 sandwiches, together with the roof 3, the upper portion of the front pillar 21.

The speaker 52 is attached to the lower surface of the roof 3. The speaker 52 is located on each of the right and left sides in the vehicle width direction. The harness 4 is drawn out of the front pillar 21 through the front pillar 21. The harness 4 drawn out through the first hole 27 is branched into lines. A first line of the lines extends along the lower surface of the roof 3 and is connected to the speaker 52. A second line of the lines extends along the lower surface of the roof 3, penetrates the roof 3 in the up-down direction, is drawn out to the upper surface of the roof 3, and is connected to the antenna 51. The antenna 51 is attached to the upper surface of the roof 3, as shown in FIG. 3.

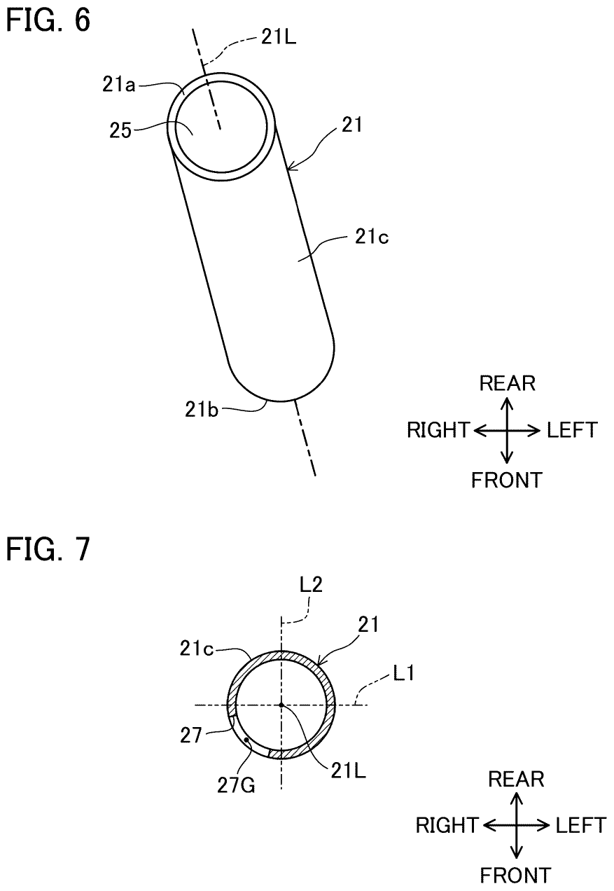

FIG. 6 is a simple plan view showing the left front pillar 21 from above. The upper end 21a of the front pillar 21 is positioned rearward of the lower end 21b of the front pillar 21. In other words, the front pillar 21 is inclined such that the upper end 21a tilts rearward. In FIG. 6, for the sake of convenience, the first hole 27 and the second hole 28 are omitted. Specifically, the front pillar 21 is inclined such that the upper end 21a tilts rearward and inward in the vehicle width direction. That is, the axis 21L of the front pillar 21 is inclined such that the upper side of the axis 21L tilts rearward and inward in the vehicle width direction. Note that the front pillar 21 may be inclined such that the upper end 21a tilts rearward and outward in the vehicle width direction.

FIG. 7 is a sectional view of the left front pillar 21 in the section extending perpendicular to the axis 21L and passing through the center of gravity 27G of the first hole 27. In the section (hereinafter also referred to as a perpendicular section) extending perpendicular to the axis 21L of the front pillar 21 and passing through the center of gravity 27G of the first hole 27, the center of gravity 27G of the first hole 27 is located forward of the axis 21L of the front pillar 21. The center of gravity 27G of the first hole 27 is the center of gravity of a three-dimensional figure corresponding to a space in the first hole 27.

Specifically, in the perpendicular section, the center of gravity 27G of the first hole 27 is positioned on the front side and inside in the vehicle width direction with respect to the axis 21L of the front pillar 21. Specifically, in the perpendicular section, it is assumed that a line passing through the axis 21L and extending parallel with the right-left direction is a first reference line L1, and a line passing through the axis 21L and extending parallel with the front-rear direction is a second reference line L2. In the perpendicular section, the center of gravity 27G of the first hole 27 is positioned forward of the first reference line L1, and is positioned inside in the vehicle width direction with respect to the second reference line L2. Note that in the perpendicular section, the center of gravity 27G of the first hole 27 may be positioned on the front side and outside in the vehicle width direction with respect to the axis 21L of the front pillar 21.

In the perpendicular section, the first hole 27 is positioned forward of the first reference line L1. Note that in the perpendicular section, part of the first hole 27 may be positioned rearward of the first reference line L1. In this case, the area of a portion of the first hole 27 positioned forward of the first reference line L1 is greater than the area of the portion of the first hole 27 positioned rearward of the first reference line L1.

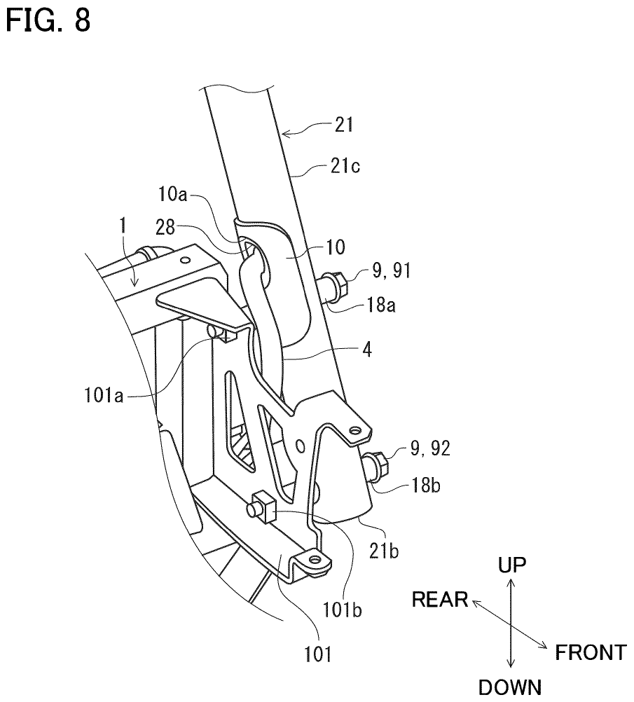

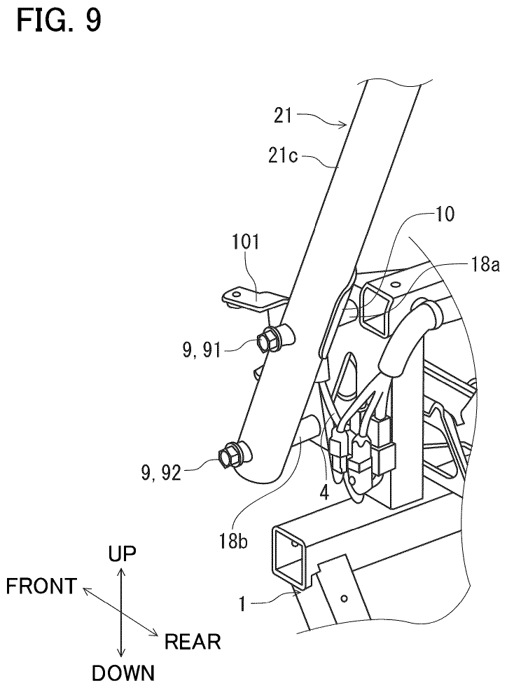

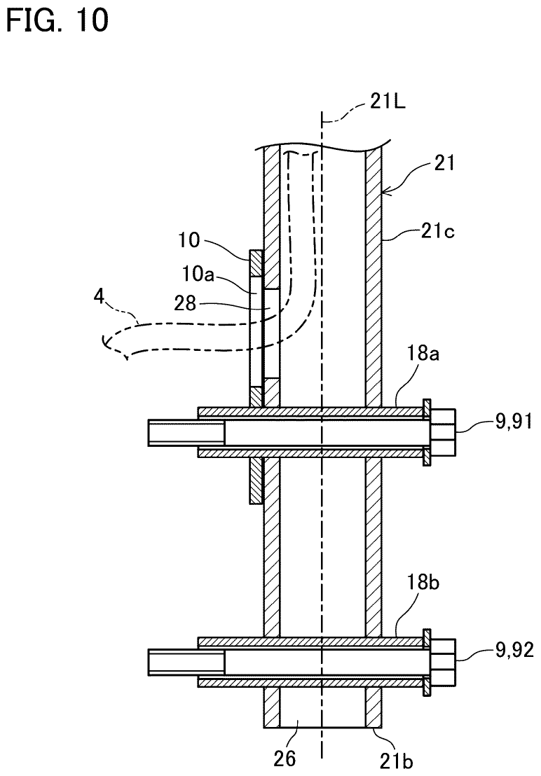

FIG. 8 is a perspective view showing, from the front and above, the state of attachment of the left front pillar 21 to the vehicle body frame 1. FIG. 9 is a perspective view showing, from the rear and above, the state of attachment of the left front pillar 21 to the vehicle body frame 1. FIG. 10 is a simple sectional view showing a lower portion of the left front pillar 21.

The vehicle 100 further has a fastening member 9 and a reinforcing plate 10. The fastening member 9 fixes the front pillar 21 to the vehicle body frame 1 with penetrating the side wall 21c of the front pillar 21. The reinforcing plate 10 is attached to the outer surface of the side wall 21c of the front pillar 21 to reinforce the front pillar 21.

Specifically, the fastening member 9 penetrates the side wall 21c of the front pillar 21 in a direction perpendicular to the axis 21L of the front pillar 21. In this example, the fastening member 9 penetrates the side wall 21c in the vehicle width direction. The fastening member 9 is positioned lower than the second hole 28. The fastening member 9 is located in the vicinity of the second hole 28.

The fastening member 9 is, for example, a bolt. The fastening member 9 includes a first fastening member 91 and a second fastening member 92. The second fastening member 92 is positioned lower than the first fastening member 91. The first fastening member 91 is located in the vicinity of the second hole 28.

The fastening member 9 penetrates the reinforcing plate 10, and the reinforcing plate 10 is located so as to surround the second hole 28. Specifically, the reinforcing plate 10 has a hole 10a facing the second hole 28. The hole 10a is larger than the second hole 28, and overlaps with the second hole 28. The reinforcing plate 10 is joined to the side wall 21c of the front pillar 21, for example, by welding.

Specifically, the vehicle 100 further has tubular members 18a, 18b. The tubular members 18a, 18b include a first tubular member 18a and a second tubular member 18b. The second tubular member 18b is positioned lower than the first tubular member 18a. The first tubular member 18a and the second tubular member 18b penetrate the side wall 21c of the front pillar 21 in a direction perpendicular to the axis 21L of the front pillar 21. In this example, the first tubular member 18a and the second tubular member 18b penetrate the side wall 21c in the vehicle width direction. The first tubular member 18a further penetrates the reinforcing plate 10. The first tubular member 18a is joined to the side wall 21c of the front pillar 21 and the reinforcing plate 10, for example, by welding. The second tubular member 18b is joined to the side wall 21c of the front pillar 21, for example, by welding.

The first fastening member 91 is inserted into the first tubular member 18a along the axis of the first tubular member 18a. Accordingly, the first fastening member 91 is located with penetrating the side wall 21c of the front pillar 21 and the reinforcing plate 10. The first fastening member 91 is inserted into the first tubular member 18a from the outside to the inside in the vehicle width direction. That is, a bolt head portion of the first fastening member 91 is positioned outside in the vehicle width direction with respect to the front pillar 21, and a bolt thread portion of the first fastening member 91 is positioned inside in the vehicle width direction with respect to the front pillar 21.

The second fastening member 92 is inserted into the second tubular member 18b along the axis of the second tubular member 18b. Accordingly, the second fastening member 92 is located with penetrating the side wall 21c of the front pillar 21. The second fastening member 92 is inserted into the second tubular member 18b from the outside to the inside in the vehicle width direction. That is, a bolt head portion of the second fastening member 92 is positioned outside in the vehicle width direction with respect to the front pillar 21, and a bolt thread portion of the second fastening member 92 is positioned inside in the vehicle width direction with respect to the front pillar 21.

Each of the first fastening member 91 and the second fastening member 92 is fixed to an attachment plate 101 of the vehicle body frame 1. Specifically, the bolt thread portion of the first fastening member 91 is fastened to a first nut portion 101a of the attachment plate 101. The bolt thread portion of the second fastening member 92 is fastened to a second nut portion 101b of the attachment plate 101.

The second hole 28 opens inside in the vehicle width direction. The harness 4 is drawn out through the second hole 28. The harness 4 drawn out through the second hole 28 extends in a space between the vehicle body frame 1 and the front pillar 21. The harness 4 drawn out through the second hole 28 is branched into lines. The lines are connected to connectors. The connectors are attached to the vehicle body frame 1.

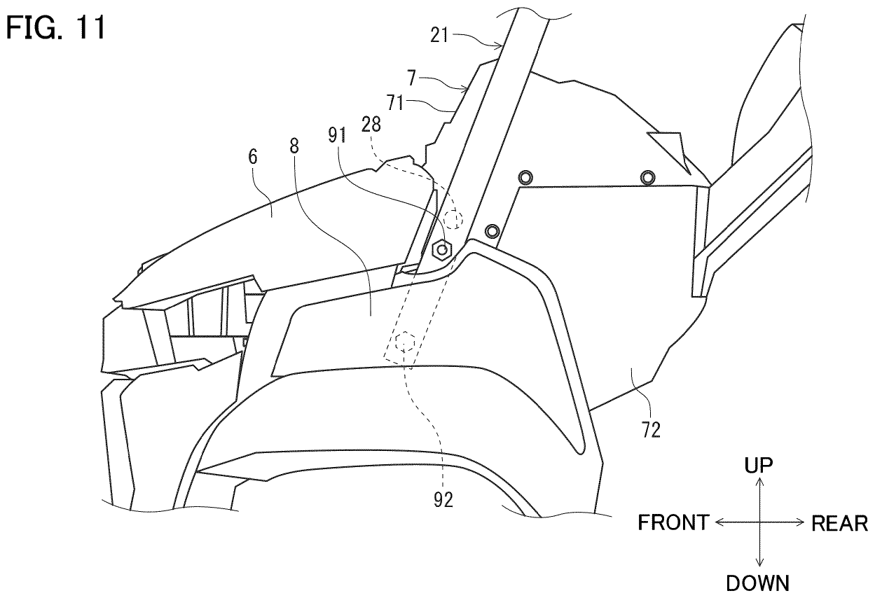

FIG. 11 is a side view showing a front portion of the vehicle 100 from the left side. As viewed in the vehicle width direction, the second hole 28 is covered with at least one of the hood 6 or the dashboard 7 from the inside in the vehicle width direction. That is, as viewed in the vehicle width direction, the second hole 28 faces at least one of the hood 6 or the dashboard 7. In this example, as viewed in the vehicle width direction, the second hole 28 faces the upper board 71 of the dashboard 7, and is covered with the upper board 71 from the inside in the vehicle width direction. Moreover, as viewed in the vehicle width direction, the harness 4 drawn out through the second hole 28 faces the upper board 71 of the dashboard 7, and is covered with the upper board 71 from the inside in the vehicle width direction.

As viewed in the vehicle width direction, the fender 8 covers, from the outside in the vehicle width direction, at least the second fastening member 92 of the first fastening member 91 or the second fastening member 92. That is, as viewed in the vehicle width direction, the fender 8 faces at least the second fastening member 92 of the first fastening member 91 or the second fastening member 92. In this example, as viewed in the vehicle width direction, the fender 8 faces the second fastening member 92, and covers the second fastening member 92 from the outside in the vehicle width direction. The first fastening member 91 is exposed to the outside of the vehicle 100.

According to the above-described vehicle 100, the drain hole 33 of the roof 3 faces and communicates with the upper end hole 25 of the front pillar 21, and therefore, the rainwater accumulated on the roof 3 can be guided from the drain hole 33 of the roof 3 into the front pillar 21 through the upper end hole 25 thereof, and can be discharged from the front pillar 21 through the lower end hole 26 thereof. In this example, the rainwater discharged through the lower end hole 26 drops onto the front wheel 13 facing the lower end hole 26. That is, the front pillar 21 can be used as a drainpipe for draining the rainwater.

The harness 4 is inserted into the front pillar 21 through the first hole 27 and second hole 28 of the front pillar 21, and therefore, the harness 4 can be drawn into the front pillar 21. That is, the front pillar 21 can be used as a cover surrounding the harness 4 and defining a drawing path for the harness 4.

In this manner, the front pillar 21 can be used not only as an upper frame of the vehicle, but also as the rainwater discharge path and the drawing path for the harness 4. Thus, even if a predetermined function is added to the vehicle, an increase in the number of components can be suppressed by use of the front pillar 21.

In the section extending perpendicular to the axis 21L of the front pillar 21 and passing through the center of gravity 27G of the first hole 27, the center of gravity 27G of the first hole 27 is positioned forward of the axis 21L of the front pillar 21. This can reduce the rainwater dropping along the side wall 21c in the front pillar 21 from leaking out through the first hole 27.

Specifically, the rainwater accumulated on the roof 3 enters the front pillar 21 through the upper end hole 25 of the front pillar 21. At this time, since the front pillar 21 is inclined such that the upper end 21a tilts rearward, the rainwater drops along a rear region of the inner surface of the side wall 21c in the front pillar 21. The center of gravity 27G of the first hole 27 is positioned forward of the axis 21L of the front pillar 21, and therefore, is positioned at a front portion of the side wall 21c of the front pillar 21. Thus, the center of gravity 27G of the first hole 27 is separated from the rear region of the inner surface of the side wall 21c of the front pillar 21, and overlap between the first hole 27 and the rear region of the inner surface of the side wall 21c can be reduced. Consequently, leakage of the rainwater inside the front pillar 21 through the first hole 27 can be reduced.

The tubular portion 34 is inserted into the upper end hole 25 of the front pillar 21, and therefore, the rainwater flowing along the drain hole 33 is guided into the front pillar 21 without leaking to the outside of the front pillar 21. Moreover, the front side wall portion 34a of the tubular portion 34 extends to the position lower than the rear side wall portion 34b of the tubular portion 34, and therefore, even in a case where the first hole 27 is positioned on the front side of the front pillar 21, the front side wall portion 34a can serve as a wall to reduce leakage of the rainwater through the first hole 27.

The second hole 28 is covered, as viewed in the vehicle width direction, with at least one of the hood 6 or the dashboard 7 from the inside in the vehicle width direction, and therefore, the harness 4 drawn out through the second hole 28 can be covered with at least one of the hood 6 or the dashboard 7.

The fastening member 9 is positioned lower than the second hole 28, and therefore, does not interfere with the harness 4 drawn into the front pillar 21 between the first hole 27 and the second hole 28.

The fender 8 covers, as viewed in the vehicle width direction, at least the second fastening member 92 of the first fastening member 91 or the second fastening member 92 from the outside in the vehicle width direction, and therefore, at least the second fastening member 92 of the first fastening member 91 or the second fastening member 92 can be hidden as viewed from the outside in the vehicle width direction.

The fastening member 9 penetrates the reinforcing plate 10, and the reinforcing plate 10 is located so as to surround the second hole 28. Thus, the strength of a reinforced portion of the front pillar 21 to which the reinforcing plate 10 is attached can be improved. Thus, even if the reinforced portion of the front pillar 21 is attached to the vehicle body frame 1 via the fastening member 9 and a load is applied to the reinforced portion of the front pillar 21, the reinforced portion of the front pillar 21 can withstand such a load. Moreover, a material inexpensive as compared to that for a stronger casted product can be used for the front pillar 21.

Specifically, the front pillar 21 is in the hollow tubular shape, and therefore, the strength of the front pillar 21 is low. Further, the front pillar 21 has the second hole 28, and therefore, the strength of a portion of the front pillar 21 around the second hole 28 is lower. When the fastening member 9 penetrates the portion of the front pillar 21 around the second hole 28 and is fixed to the vehicle body frame 1, a great load is applied to the portion of the front pillar 21 around the second hole 28. Thus, the reinforcing plate 10 is attached to the portion of the front pillar 21 around the second hole 28 so that the strength of the portion of the front pillar 21 around the second hole 28 can be improved and the portion of the front pillar 21 around the second hole 28 can withstand such a load.

### First Modification

Next, a vehicle (one example of the vehicle) according to a first modification will be described mainly with reference to FIGS. 1 and 10. The vehicle according to the first modification may be configured without the roof 3, unlike the vehicle 100 according to the embodiment. In the first modification, the same reference numerals as those of the embodiment represent the same components as those of the embodiment, and therefore, description thereof will be omitted. Hereinafter, the vehicle according to the first modification will be described as the vehicle 100 shown in FIG. 1.

The vehicle 100 according to the first modification includes the vehicle body frame 1, the hollow tubular front pillar 21 (one example of a pillar) attached to the vehicle body frame 1 and extending in the up-down direction, the harness 4 connected to the electric component 5, the fastening member 9 penetrating the side wall 21c of the front pillar 21 and fixing the front pillar 21 to the vehicle body frame 1, and the reinforcing plate 10 attached to the outer surface of the side wall 21c of the front pillar 21.

The front pillar 21 has the second hole 28 (one example of a hole) opening in the side wall 21c. The harness 4 is inserted into the front pillar 21 through the second hole 28. The second hole 28 is positioned in the vicinity of the fastening member 9. The fastening member 9 penetrates the reinforcing plate 10, and the reinforcing plate 10 is located so as to surround the second hole 28. The fastening member 9 is positioned lower than the second hole 28.

According to the vehicle 100 of the first modification, the harness 4 is inserted into the front pillar 21 through the second hole 28 of the front pillar 21, and therefore, can be drawn into the front pillar 21. That is, the front pillar 21 can be used as the cover surrounding the harness 4 and defining the drawing path for the harness 4.

In this manner, the front pillar 21 can be used not only as the upper frame of the vehicle, but also as the drawing path for the harness 4. Thus, even if a predetermined function is added to the vehicle, an increase in the number of components can be suppressed by use of the front pillar 21.

The fastening member 9 penetrates the reinforcing plate 10, and the reinforcing plate 10 is located so as to surround the second hole 28. Thus, the strength of the reinforced portion of the front pillar 21 to which the reinforcing plate 10 is attached can be improved. Thus, even if the reinforced portion of the front pillar 21 is attached to the vehicle body frame 1 via the fastening member 9 and a load is applied to the reinforced portion of the front pillar 21, the reinforced portion of the front pillar 21 can withstand such a load. Moreover, a material inexpensive as compared to that for a stronger casted product can be used for the front pillar 21.

Specifically, the front pillar 21 is in the hollow tubular shape, and therefore, the strength of the front pillar 21 is low. Further, the front pillar 21 has the second hole 28, and therefore, the strength of the portion of the front pillar 21 around the second hole 28 is lower. When the fastening member 9 penetrates the portion of the front pillar 21 around the second hole 28 and is fixed to the vehicle body frame 1, a great load is applied to the portion of the front pillar 21 around the second hole 28. Thus, the reinforcing plate 10 is attached to the portion of the front pillar 21 around the second hole 28 so that the strength of the portion of the front pillar 21 around the second hole 28 can be improved and the portion of the front pillar 21 around the second hole 28 can withstand such a load.

The fastening member 9 is positioned lower than the second hole 28, and therefore, does not interfere with the harness 4 drawn into the front pillar 21 in a case where the harness 4 is drawn to a position higher than the second hole 28 in the front pillar 21.

Note that although description of other configurations, features, and effects will be omitted, the description of the vehicle 100 according to the embodiment may be used for the description of the vehicle 100 according to the first modification.

### Second Modification

Next, a vehicle (one example of the vehicle) according to a second modification will be described mainly with reference to FIGS. 1 and 2. The vehicle according to the second modification may be configured without the harness 4, unlike the vehicle 100 according to the embodiment. In the second modification, the same reference numerals as those of the embodiment represent the same components as those of the embodiment, and therefore, description thereof will be omitted. Hereinafter, the vehicle according to the second modification will be described as the vehicle 100 shown in FIG. 1.

The vehicle 100 according to the second modification includes the vehicle body frame 1, the pillars 2 attached to the vehicle body frame 1 and extending in the up-down direction, and the roof 3 supported by the pillars 2. The pillars 2 include the hollow tubular front pillar 21 (one example of the first pillar). The front pillar 21 has the upper end hole 25 opening at the upper end 21a and the lower end hole 26 opening at the lower end 21b. The roof 3 has the drain hole 33. The drain hole 33 faces and communicates with the upper end hole 25.

According to the vehicle 100 of the second modification, the drain hole 33 of the roof 3 faces and communicates with the upper end hole 25 of the front pillar 21, and therefore, the rainwater accumulated on the roof 3 can be guided from the drain hole 33 of the roof 3 into the front pillar 21 through the upper end hole 25 thereof, and can be discharged from the front pillar 21 through the lower end hole 26 thereof. That is, the front pillar 21 can be used as the drainpipe for draining the rainwater.

In this manner, the front pillar 21 can be used not only as the upper frame of the vehicle, but also as the rainwater discharge path. Thus, even if a predetermined function is added to the vehicle, an increase in the number of components can be suppressed by use of the front pillar 21.

Note that although description of other configurations, features, and effects will be omitted, the description of the vehicle 100 according to the embodiment may be used for the description of the vehicle 100 according to the second modification.

### Other Embodiments

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

The vehicle 100 may be configured such that entrances on the right and left sides of the seats are closed with walls or doors. In this case, the door is openable, and the occupant can get on and off the vehicle 100 by opening the door.

The vehicle 100 may be a single-seated vehicle. The vehicle 100 may have only one seat or three or more seats in the front-rear direction. The vehicle 100 may be a three-wheeled vehicle having three wheels or a six-wheeled vehicle having six wheels.

The number of pillars 2 may be freely increased or decreased. The pillars 2 include the front pillar 21, the center pillar 22, and the rear pillar 23, but the center pillar 22 may be omitted.

The section of the front pillar 21 is in the circular shape, but may be in other shapes such as an elliptical shape and a polygonal shape. The same also applies to the center pillar 22 and the rear pillar 23.

The left front pillar 21 has been described as one example of the first pillar of the present disclosure, but the right front pillar 21 may have a similar configuration.

The front pillar 21 has been described as one example of the first pillar of the present disclosure, but the center pillar 22 and the rear pillar 23 may have a similar configuration. That is, as in the front pillar 21, the center pillar 22 and the rear pillar 23 may be equivalent to one example of the first pillar of the present disclosure. Alternatively, at least one of the front pillar 21, the center pillar 22, or the rear pillar 23 may be equivalent to one example of the first pillar of the present disclosure. The pillar 2 which is not equivalent to one example of the first pillar of the present disclosure is not necessarily hollow, but may be solid.

The drain 30 has, in the bottom thereof, the drain hole 33 of the roof 3, but the roof 3 may have, in the upper surface thereof, the drain hole 33 without the drain 30. Alternatively, the roof 3 may have a recess over the substantially entirety of the upper surface thereof, and the recess may have the drain hole 33 in the bottom thereof.

The drain hole 33 may be located at a connection portion between the right first groove 31 and the front second groove 32. In this case, the second groove 32 has a shape extending downward to the outside in the vehicle width direction. The right front pillar 21 has the upper end hole 25 and the lower end hole 26 as in the left front pillar 21. The right drain hole 33 faces and communicates with the upper end hole 25 of the right front pillar 21. With this configuration, the rainwater is guided into the front pillar 21 through the drain hole 33. The rainwater inside the front pillar 21 is discharged to the outside through the lower end hole 26.

The upper end 21a of the front pillar 21 is positioned rearward of the lower end 21b of the front pillar 21, but may be at the same position as that of the lower end 21b in the front-rear direction or may be positioned forward of the lower end 21b. The front pillar 21 is inclined such that the upper end 21a tilts rearward, but may extend substantially vertically in the up-down direction or may be inclined such that the upper end 21a tilts forward.

In the section extending perpendicular to the axis 21L of the front pillar 21 and passing through the center of gravity 27G of the first hole 27, the center of gravity 27G of the first hole 27 is positioned forward of the axis 21L of the front pillar 21, but may be positioned rearward of the axis 21L of the front pillar 21.

The front side wall portion 34a of the tubular portion 34 extends to the position lower than the rear side wall portion 34b of the tubular portion 34, but the rear side wall portion 34b may extend to a position lower than the front side wall portion 34a or the lower end of the front side wall portion 34a may be at the same position as that of the lower end of the rear side wall portion 34b in the up-down direction.

The number of fastening members 9 may be freely increased or decreased. The fastening member 9 is positioned lower than the second hole 28, but may be positioned higher than the second hole 28. The reinforcing plate 10 may be omitted.

The second hole 28 is covered, as viewed in the vehicle width direction, with the dashboard 7 from the inside in the vehicle width direction, but may be covered with the hood 6 from the inside in the vehicle width direction or may be covered with the hood 6 and the dashboard 7 from the inside in the vehicle width direction. Alternatively, as viewed in the vehicle width direction, the second hole 28 is not necessarily covered with the hood 6 and the dashboard 7 from the inside in the vehicle width direction.

The fender 8 covers, as viewed in the vehicle width direction, the second fastening member 92 from the outside in the vehicle width direction, but may cover the first fastening member 91 and the second fastening member 92 from the outside in the vehicle width direction. Alternatively, as viewed in the vehicle width direction, the fender 8 does not necessarily cover the second fastening member 92 from the outside in the vehicle width direction. That is, the second fastening member 92 may be exposed to the outside of the vehicle 100.

The vehicle of the present disclosure may be an off-road vehicle or an on-road vehicle. The off-road vehicle may be, for example, a utility vehicle, a side-by-side vehicle, or a tractor.

### [Aspects]

The above-described embodiment is a specific example of the following aspects.

### (First Aspect)

The vehicle (utility vehicle 100) includes the vehicle body frame 1, the pillars 2 attached to the vehicle body frame 1 and extending in the up-down direction, the roof 3 supported by the pillars 2, and the harness 4 connected to the electric component 5, the pillars 2 include the hollow tubular front pillar 21 (one example of the first pillar), the front pillar 21 has the upper end hole 25 opening at the upper end 21a, the lower end hole 26 opening at the lower end 21b, the first hole 27 opening in the side wall 21c, and the second hole 28 opening in the side wall 21c and positioned lower than the first hole 27, the roof 3 has the drain hole 33, the drain hole 33 faces and communicates with the upper end hole 25, and the harness 4 is inserted into the front pillar 21 through the first hole 27 and the second hole 28.

According to this configuration, the front pillar 21 can be used not only as the upper frame of the vehicle, but also as the rainwater discharge path and the drawing path for the harness 4. Thus, even if a predetermined function is added to the vehicle, an increase in the number of components can be suppressed by use of the front pillar 21.

### (Second Aspect)

In the vehicle of the first aspect, the upper end 21a of the front pillar 21 is positioned rearward of the lower end 21b of the front pillar 21, and in the section extending perpendicular to the axis 21L of the front pillar 21 and passing through the center of gravity 27G of the first hole 27, the center of gravity 27G of the first hole 27 is positioned forward of the axis 21L of the front pillar 21.

According to this configuration, in the section extending perpendicular to the axis 21L of the front pillar 21 and passing through the center of gravity 27G of the first hole 27, the center of gravity 27G of the first hole 27 is positioned forward of the axis 21L of the front pillar 21. This can reduce the rainwater dropping along the side wall 21c in the front pillar 21 from leaking out through the first hole 27.

### (Third Aspect)

In the vehicle of the first or second aspect, the roof 3 has the tubular portion 34 penetrating the lower surface of the roof 3 and protruding downward, the drain hole 33 is equivalent to the inside of the tubular portion 34, the tubular portion 34 is inserted into the upper end hole 25 of the front pillar 21, and the front side wall portion 34a of the tubular portion 34 extends to the position lower than the rear side wall portion 34b of the tubular portion 34.

According to this configuration, the tubular portion 34 is inserted into the upper end hole 25 of the front pillar 21, and therefore, the rainwater flowing along the drain hole 33 is guided into the front pillar 21 without leaking to the outside of the front pillar 21. Moreover, the front side wall portion 34a of the tubular portion 34 extends to the position lower than the rear side wall portion 34b of the tubular portion 34, and therefore, even in a case where the first hole 27 is positioned on the front side of the front pillar 21, the front side wall portion 34a can serve as the wall to reduce leakage of the rainwater through the first hole 27.

### (Fourth Aspect)

In the vehicle of any one of the first to third aspects, the roof 3 has the drain 30, the drain 30 has the front side wall 30a, the drain 30 has, in the bottom 30b thereof, the drain hole 33, and the drain hole 33 is located at the position apart rearward from the front side wall 30a.

According to this configuration, the drain hole 33 is located at the position apart rearward from the front side wall 30a, and therefore, the rainwater flowing forward along the drain 30 of the roof 3 is drained through the drain hole 33 before reaching the front side wall 30a. This can reduce the rainwater from flowing over the front side wall 30a and dropping from the front of the roof 3.

### (Fifth Aspect)

The vehicle of any one of the first to fourth aspects further includes the hood 6 attached to the front portion of the vehicle body frame 1, and the dashboard 7 attached to the vehicle body frame 1 in rear of the hood 6, the second hole 28 opens inside in the vehicle width direction, and as viewed in the vehicle width direction, the second hole 28 is covered with at least one of the hood 6 or the dashboard 7 from the inside in the vehicle width direction.

According to this configuration, the second hole 28 is covered, as viewed in the vehicle width direction, at least one of the hood 6 or the dashboard 7 from the inside in the vehicle width direction, and therefore, the harness 4 drawn out through the second hole 28 can be covered with at least one of the hood 6 or the dashboard 7.

### (Sixth Aspect)

The vehicle of any one of the first to fifth aspects further includes the fastening member 9 penetrating the side wall 21c of the front pillar 21 and fixing the front pillar 21 to the vehicle body frame 1, and the fastening member 9 is positioned lower than the second hole 28.

According to this configuration, the fastening member 9 is positioned lower than the second hole 28, and therefore, does not interfere with the harness 4 drawn into the front pillar 21 between the first hole 27 and the second hole 28.

### (Seventh Aspect)

In the vehicle of any one of the first to sixth aspect, the fastening member 9 includes the first fastening member 91 and the second fastening member 92 positioned lower than the first fastening member 91, and the vehicle further includes the fender 8 covering, as viewed in the vehicle width direction, at least the second fastening member 92 of the first fastening member 91 or the second fastening member 92 from the outside in the vehicle width direction.

According to this configuration, the fender 8 covers, as viewed in the vehicle width direction, at least the second fastening member 92 of the first fastening member 91 or the second fastening member 92 from the outside in the vehicle width direction, and therefore, at least the second fastening member 92 of the first fastening member 91 or the second fastening member 92 can be hidden as viewed from the outside in the vehicle width direction.

### (Eighth Aspect)

The vehicle of any one of the first to seventh aspects further includes the reinforcing plate 10 attached to the outer surface of the side wall 21c of the front pillar 21, the fastening member 9 penetrates the reinforcing plate 10, and the reinforcing plate 10 is located so as to surround the second hole 28.

According to this configuration, the fastening member 9 penetrates the reinforcing plate 10, and the reinforcing plate 10 is located so as to surround the second hole 28. Thus, the strength of the reinforced portion of the front pillar 21 to which the reinforcing plate 10 is attached can be improved. Thus, even if the reinforced portion of the front pillar 21 is attached to the vehicle body frame 1 via the fastening member 9 and the load is applied to the reinforced portion of the front pillar 21, the reinforced portion of the front pillar 21 can withstand such a load. Moreover, the material inexpensive as compared to that for the stronger casted product can be used for the front pillar 21.

### (Ninth Aspect)

The vehicle of any one of the first to eighth aspects is the utility vehicle.

### (Tenth Aspect)

The vehicle (e.g., utility vehicle) includes the vehicle body frame 1, the hollow tubular front pillar 21 (one example of the pillar) attached to the vehicle body frame 1 and extending in the up-down direction, the harness 4 connected to the electric component 5, the fastening member 9 penetrating the side wall 21c of the front pillar 21 and fixing the front pillar 21 to the vehicle body frame 1, and the reinforcing plate 10 attached to the outer surface of the side wall 21c of the front pillar 21, the front pillar 21 has the second hole 28 (one example of the hole) opening in the side wall 21c, the harness 4 is inserted into the front pillar 21 through the second hole 28, the second hole 28 is positioned in the vicinity of the fastening member 9, the fastening member 9 penetrates the reinforcing plate 10, and the reinforcing plate 10 is located so as to surround the second hole 28.

According to this configuration, the front pillar 21 can be used not only as the upper frame of the vehicle, but also as the drawing path for the harness 4. Thus, even if a predetermined function is added to the vehicle, an increase in the number of components can be suppressed by use of the front pillar 21.

The fastening member 9 penetrates the reinforcing plate 10, and the reinforcing plate 10 is located so as to surround the second hole 28. Thus, the strength of the reinforced portion of the front pillar 21 to which the reinforcing plate 10 is attached can be improved. Thus, even if the reinforced portion of the front pillar 21 is attached to the vehicle body frame 1 via the fastening member 9 and the load is applied to the reinforced portion of the front pillar 21, the reinforced portion of the front pillar 21 can withstand such a load. Moreover, the material inexpensive as compared to that for the stronger casted product can be used for the front pillar 21.

### (Eleventh Aspect)

In the vehicle of the tenth aspect, the fastening member 9 is positioned lower than the second hole 28.

According to this configuration, the fastening member 9 is positioned lower than the second hole 28, and therefore, does not interfere with the harness 4 drawn into the front pillar 21 in a case where the harness 4 is drawn to the position higher than the second hole 28 in the front pillar 21.

### (Twelfth Aspect)

The vehicle (e.g., utility vehicle) includes the vehicle body frame 1, the pillars 2 attached to the vehicle body frame 1 and extending in the up-down direction, and the roof 3 supported by the pillars 2, the pillars 2 include the hollow tubular front pillar 21 (one example of the first pillar), the front pillar 21 has the upper end hole 25 opening at the upper end 21a and the lower end hole 26 opening at the lower end 21b, the roof 3 has the drain hole 33, and the drain hole 33 faces and communicates with the upper end hole 25.

According to this configuration, the front pillar 21 can be used not only as the upper frame of the vehicle, but also as the rainwater discharge path. Thus, even if a predetermined function is added to the vehicle, an increase in the number of components can be suppressed by use of the front pillar 21.

What is claimed:

1. A vehicle comprising:
a vehicle body frame;
pillars attached to the vehicle body frame and extending in an up-down direction;
a roof supported by the pillars; and
a harness connected to an electric component,
wherein the pillars include a hollow tubular first pillar,
the first pillar has an upper end hole opening at an upper end, a lower end hole opening at a lower end, a first hole opening in a side wall, and a second hole opening in the side wall and positioned lower than the first hole,
the roof has a drain hole, and the drain hole faces and communicates with the upper end hole, and
the harness is inserted into the first pillar through the first hole and the second hole.

2. The vehicle of claim 1, wherein
the upper end of the first pillar is positioned rearward of the lower end of the first pillar, and
in a section extending perpendicular to an axis of the first pillar and passing through a center of gravity of the first hole, the center of gravity of the first hole is positioned forward of the axis of the first pillar.

3. The vehicle of claim 1, wherein
the roof has a tubular portion penetrating a lower surface of the roof and protruding downward, the drain hole is equivalent to an inside of the tubular portion, and the tubular portion is inserted into the upper end hole of the first pillar, and
a front side wall portion of the tubular portion extends to a position lower than a rear side wall portion of the tubular portion.

4. The vehicle of claim 1, wherein
the roof has a drain,
the drain has a front side wall, and
the drain has, in a bottom thereof, the drain hole, and the drain hole is located at a position apart rearward from the front side wall.

5. The vehicle of claim 1, further comprising:
a hood attached to a front portion of the vehicle body frame; and
a dashboard attached to the vehicle body frame in rear of the hood,
wherein the second hole opens inside in a vehicle width direction, and
as viewed in the vehicle width direction, the second hole is covered with at least one of the hood or the dashboard from the inside in the vehicle width direction.

6. The vehicle of claim 1, further comprising:
a fastening member penetrating the side wall of the first pillar and fixing the first pillar to the vehicle body frame,
wherein the fastening member is positioned lower than the second hole.

7. The vehicle of claim 6,
the fastening member including a first fastening member and a second fastening member positioned lower than the first fastening member, the vehicle further comprising:
a fender covering, as viewed in a vehicle width direction, at least the second fastening member of the first fastening member or the second fastening member from an outside in the vehicle width direction.

8. The vehicle of claim 6, further comprising:
a reinforcing plate attached to an outer surface of the side wall of the first pillar,
wherein the fastening member penetrates the reinforcing plate, and the reinforcing plate is located so as to surround the second hole.

9. The vehicle of claim 1, wherein
the vehicle is a utility vehicle.

10. A vehicle comprising:
a vehicle body frame;
a hollow tubular pillar attached to the vehicle body frame and extending in an up-down direction;
a harness connected to an electric component;
a fastening member penetrating a side wall of the pillar and fixing the pillar to the vehicle body frame; and
a reinforcing plate attached to an outer surface of the side wall of the pillar,
wherein the pillar has a hole opening in the side wall,
the harness is inserted into the pillar through the hole,
the hole is positioned in a vicinity of the fastening member, and
the fastening member penetrates the reinforcing plate, and the reinforcing plate is located so as to surround the hole.

11. The vehicle of claim 10, wherein
the fastening member is positioned lower than the hole.

12. A vehicle comprising:
a vehicle body frame;
pillars attached to the vehicle body frame and extending in an up-down direction; and
a roof supported by the pillars,
wherein the pillars include a hollow tubular first pillar,
the first pillar has an upper end hole opening at an upper end and a lower end hole opening at a lower end, and
the roof has a drain hole, and the drain hole faces and communicates with the upper end hole.
